(19) United States
(12) Patent Application Publication
(10) Pub. No.: US 2003/0223322 A1
(43) Pub. Date: Dec. 4, 2003

(54) Production of master recording media

(76) Inventor: John Quinn, Castlebar (IE)

Correspondence Address: JACOBSON HOLMAN PLLC, 400 SEVENTH STREET N.W., SUITE 600, WASHINGTON, DC, 20004, US

(21) Appl. No.: 10/464,449

(22) Filed: Jun. 19, 2003

Related U.S. Application Data
(63) Continuation of application No. PCT/IE01/00160, filed on Dec. 20, 2001.

(30) Foreign Application Priority Data
Dec. 20, 2000 (IE) 2000/1059
Mar. 13, 2001 (IE) 2001/0240

(51) Int. Cl. G11B 7/085

(52) U.S. Cl. 369/30.32; 369/44.23; 369/30.33

(57) ABSTRACT

A CD master production system (1) has a pre-recording station (2) with a central robotic arm (6) for loading and unloading discs onto a succession of processing devices (19-24) including washing and resist application devices. An LBR station (3) performs laser recording on up to four substrate discs (D) at a time, mounted on spindles (41). There is real time recording head (51) height adjustment for focusing the recording beam to compensate for disc surface level variations. A sensing beam reflected from the disc is compared with a reference beam so that the phase difference indicates level variations. A post-recording station (4) performs post-recording operations, again with disc load/unload performed by a central rotating robotic arm (9). The recording station (4) is mechanically isolated from the pre and post-recording stations (2, 4).

### FIELD OF THE INVENTION

The invention relates to production of master recording media such as master DVDs or CDs.

### PRIOR ART DISCUSSION

In a typical known master DVD or CD production process a highly polished glass disc-shaped substrate is washed and a thin layer of photoresist is applied. The photoresist is cured, and a laser beam recorder (LBR) exposes the cured resist using a laser beam. The resist exposed to the laser beam is developed away, and a thin coating of metal (such as nickel) is coated onto the glass where the resist has been developed away. The remaining resist is then removed, leaving a pattern of metal on the glass according to the desired content of the CD or DVD.

U.S. Pat. No. 5,717,676 (Sony) describes an LBR process. Light is modulated by a modulator according to recording information. The light is generated by additive frequency mixing of light from two sources of different wavelengths. A laser lens is moved according to server signals for focusing by an electromagnetic actuator having components such as a coil spring mounted between plates.

While developments have been made at improving master recording, there is still considerable room for improvement of quality. One problem is jitter, caused by variations in shape and size of the laser spot on the medium, in turn caused by variations in thickness and surface angle and level of the medium. For example, lack of flatness in a glass disc can cause a “rolling effect” variation of glass disc surface of up to tens of nanometers. It does not appear that prior systems cater for these effects.

There is also a need for increased productivity, due to a requirement for shorter batch runs in the software industry.

### SUMMARY OF THE INVENTION

According to the invention, there is provided a master recording medium production system comprising a controller, a table supporting a spindle for supporting a recording medium substrate, a recording head for delivering a recording laser beam onto the substrate, a drive means for moving the recording head, and focusing means for focusing the recording laser beam, characterised in that, the focusing means comprises means for dynamically compensating for variations in level of the substrate during recording.

Such dynamic compensation helps to ensure that jitter is eliminated or at least very substantially reduced. Variations in substrate surface level would otherwise cause the recording beam spot to change in shape and size, thus moving the recording location from that desired.

In one embodiment, the focusing means comprises a transducer mounted to dynamically vary position of the recording head.

In one embodiment, the transducer is of the type in which crystals expand and contract in response to a sensing signal. Such a transducer type is particularly suitable for this application.

In one embodiment, the transducer is a piezoelectric transducer.

In another embodiment, the focusing means comprises means for directing a sensing laser beam at the substrate and means for monitoring reflection of the sensing beam.

In one embodiment, the focusing means comprises means for monitoring phase difference between the reflected sensing beam and a reference beam. Thus the monitoring is independent of factors such as the sensed intensity, and there is good accuracy because a very small substrate surface level variation will be immediately and clearly represented as a phase difference.

In a further embodiment, the focusing means comprises means for extracting the sensing and the reference beams from a single beam.

In one embodiment, the focusing means comprises means for monitoring intensity of the reflected sensing beam.

In one embodiment, the sensing beam has a wavelength in the range of 200 nm to 700 nm.

In a further embodiment, the spindle and the recording head are mounted on a table and the system further comprises a pre-recording station for performing pre-recording operations and a post-recording station for performing post-recording operations.

In one embodiment, the table is mounted on a damping mechanism independently of the pre-recording station and the post-recording station, for mechanical isolation.

In one embodiment, the pre-recording station and the post-recording station each comprise a plurality of processing devices mounted in a generally circular arc, and a robotic arm comprising means for picking and placing a substrate at each processing device.

In one embodiment, each robotic arm is centrally mounted and comprises means for accessing processing devices by rotation about a vertical axis.

In one embodiment, each robotic arm has a span encompassing the spindle and comprises locators for engagement with corresponding locators on the table. This very effectively ensures synchronisation of the robotic arm datum with that of the recording station.

In another embodiment, the table locators comprise means for presenting a spherical surface to the robotic arm locators, and the robotic arm locators comprise a pin having a circular rim for engagement with a table locator, a pin having a V-shaped grove for engagement with a table locator, and a pin having a flat surface for engagement with a table locator.

In one embodiment, the system further comprises a laser source mounted on the underside of the table, and the table has an aperture for passage of a laser beam from the source to the recording head.

In one embodiment, the recording head is mounted on a carriage driven by a linear motor having an air bearing, said linear motor also supporting an optical system and a shutter for delivering a beam to the recording head.

In one embodiment, the system comprises a plurality of spindles, and a recording head associated with each spindle.

In one embodiment, the recording heads are mounted on a linear motor having an air bearing.

In one embodiment, each spindle is mounted within a cavity in the table.

In a further embodiment, the controller comprises a fieldbus system having a node associated with each processing device, with each spindle, and with each recording head.

Preferably, the fieldbus system comprises a safety system controller connected to remote safety modules.

In one embodiment, the controller comprises a Web interface for remote control using a browser.

In one embodiment, the controller comprises means for transmitting wireless notification signals to a mobile device in a mobile network.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIGS. 1 and 2 are plan and elevation views respectively of a CD master production system of the invention;

FIGS. 3 and 4 are plan views showing an LBR station in operation, and FIG. 5 is a cross-sectional elevational view;

FIG. 6 is a diagrammatic elevational view of a recording head of the system;

FIGS. 7 and 8 are diagrammatic elevational views showing operation of a robot end effector of the system;

FIGS. 9 and 10 are diagrammatic perspective views from above showing locator pins in operation;

FIG. 11 is a diagram illustrating optical paths in the system;

FIGS. 12 to 17 inclusive are plots illustrating the optical signals;

FIGS. 18 and 19 are block diagrams illustrating a field bus architecture of the system;

FIGS. 20 to 23 are block diagrams illustrating Web interfaces; and

FIG. 24 is a block diagram illustrating GSM communication architecture.

### DESCRIPTION OF THE EMBODIMENTS

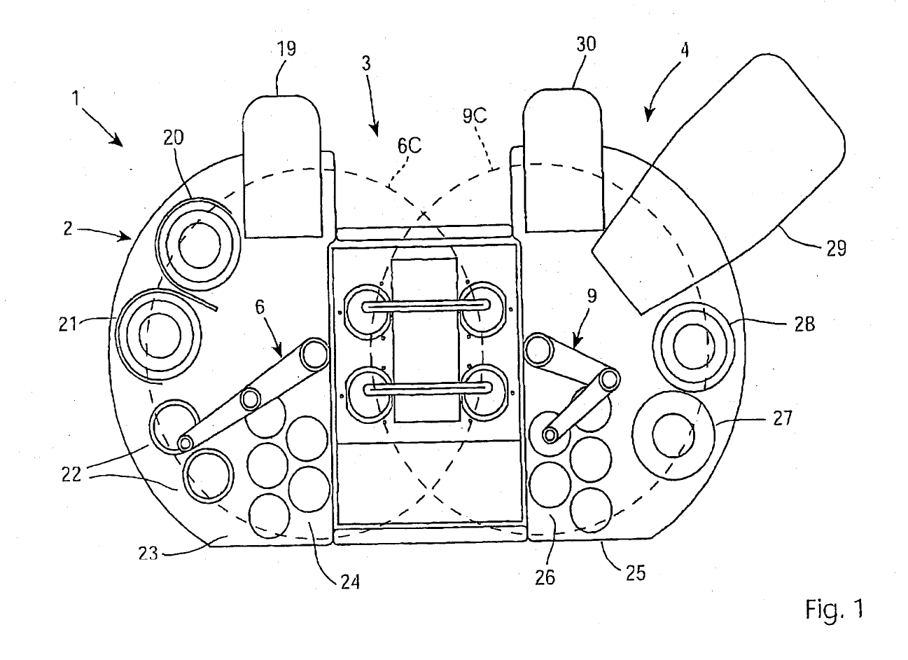

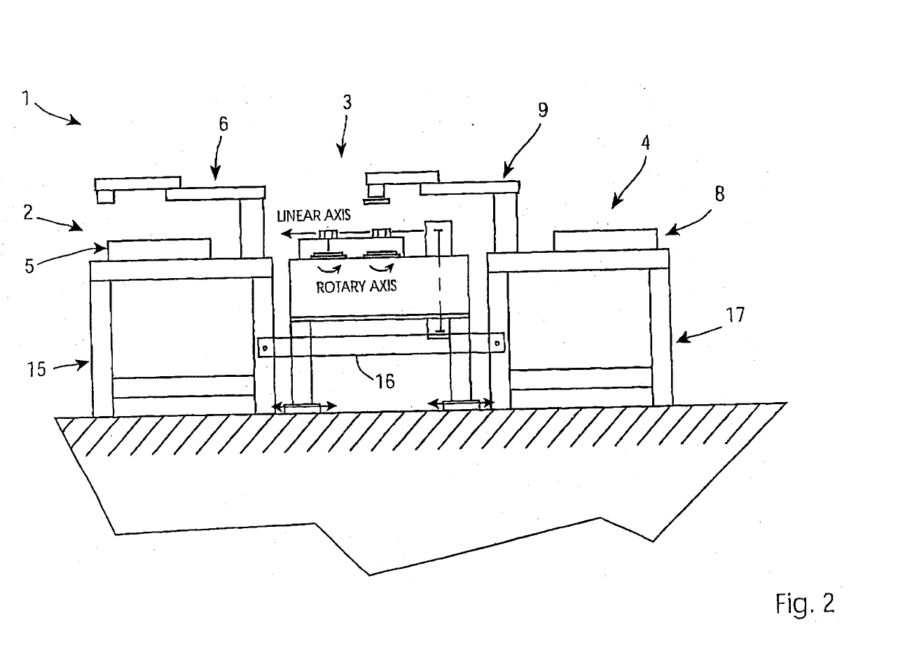

Referring to FIGS. 1 and 2 a CD master production system 1 comprises a pre-LBR station 2, an LBR station 3 and a post-LBR station 4. The pre-LBR station 2 comprises processing devices 5 served by a robotic arm 6, and the post-LBR station 2 comprises processing devices 8 served by a robotic arm 9. As shown most clearly in FIG. 2, the station 2 comprises a frame 15, the station 4 comprises a frame 17, and the frames 15 and 17 are interconnected by a link frame 16. The LBR station 3 is independently mounted, as described in more detail below.

As shown most clearly in FIG. 1, the pre-LBR station 2 comprises:

a glass substrate disc loading magazine 19,

a cleaning device 20 in which water and an adhesion promoter are applied to discs,

a resist spin-coating device 21,

two hot plates 22 having low-level suction to retain a disc, and a heating element to cure the resist, and

cooling plates 23 and 24 for cooling and buffering discs before laser recording, and removal of samples from the plates.

Thus, the pre-LBR station 2 provides automatic processing and buffering of discs D in an efficient manner before laser recording. The robotic arm 6 performs all disc handling as its reach spans all of the processing devices, as indicated by the interrupted line circle 6C.

The post-LBR station 4 comprises:

buffering and sample-remove plates 25 and 26,

a UV treatment device 27 for changing resist properties so that non-exposed resist can be more easily removed;

a developing device 28 including a water wash function,

a sputtering device 29 for application of a metal compound to a thickness of less than 200 nm, and

an unload device 30.

Again, there is highly efficient automated processing of the substrate discs D. Both of the stations 2 and 4 are robust because of use of a single robotic arm in each having a span encompassing all of the processing devices (for the station 4, circle 9C). It will also be appreciated from FIG. 1 that the spans also encompass the LBR station 3 where they overlap. Thus, the robotic arm 6 loads and unloads for the processing devices 5 and also loads onto the LBR station 3, and the arm 9 unloads from the LBR station 3 and loads/unloads for the processing devices 8.

Referring to FIGS. 3 to 6 inclusive the LBR station 3 comprises a granite platter 40 within which are four air bearing spindles 41, two on each side of an air bearing linear motor 42 having a linear axis 43. The platter 40 is mounted, independently of the pre and post-LBR stations 2 and 4, on damping feet 35 to damp any vibration arising from operation of the station 3 and to isolate it from vibration arising from operation of the stations 2 and 4. The primary sources of vibration and mechanical shock in the system 1 are the robotic arms 6 and 9, and these sources are isolated from the LBR station 3.

Five laser sources are mounted in a housing 46 underneath the platter 40. Beams from the laser sources are directed upwardly through an aperture 47, and are then guided by an optical system 48 over the linear motor 42. Beam direction optics 49 reflect the recording beams to the associated spindles 41. For each beam there is a shutter 50, and a recording head 51 over the spindle 41. Because the laser sources are mounted at the underside of the platter 40 the heat generated by them is isolated from the recording heads 51. Also, this arrangement helps to minimise system footprint.

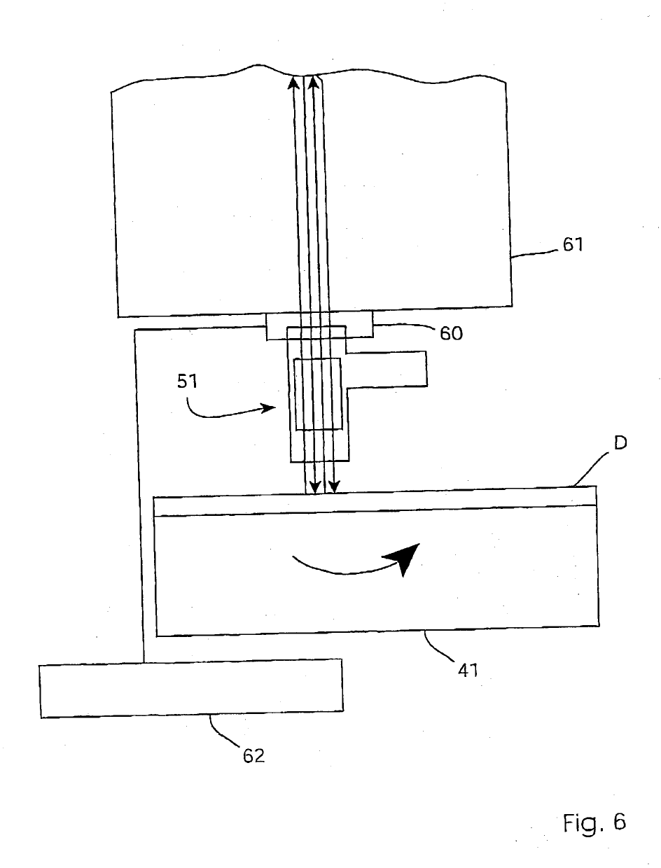

As shown in FIG. 6, the recording head 51 is connected by a movement transducer 60 to a mechanical support 61 driven by the linear motor 42. The transducer 60 moves the head 51 dynamically in real time to accommodate variations in level of the disc surface to ensure a consistent laser spot. The transducer 60 is controlled by a controller 62, described in more detail below.

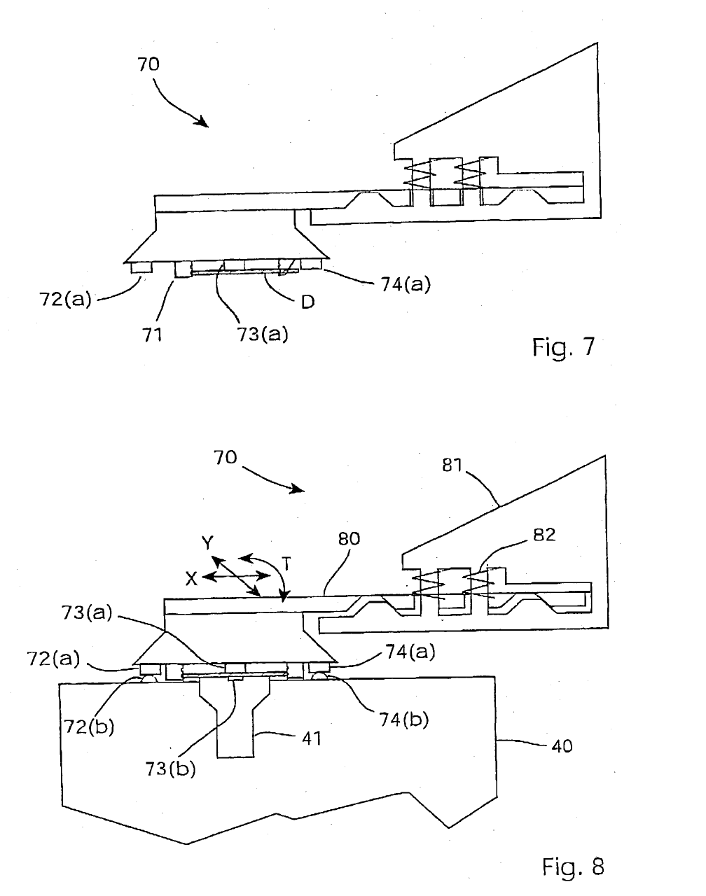

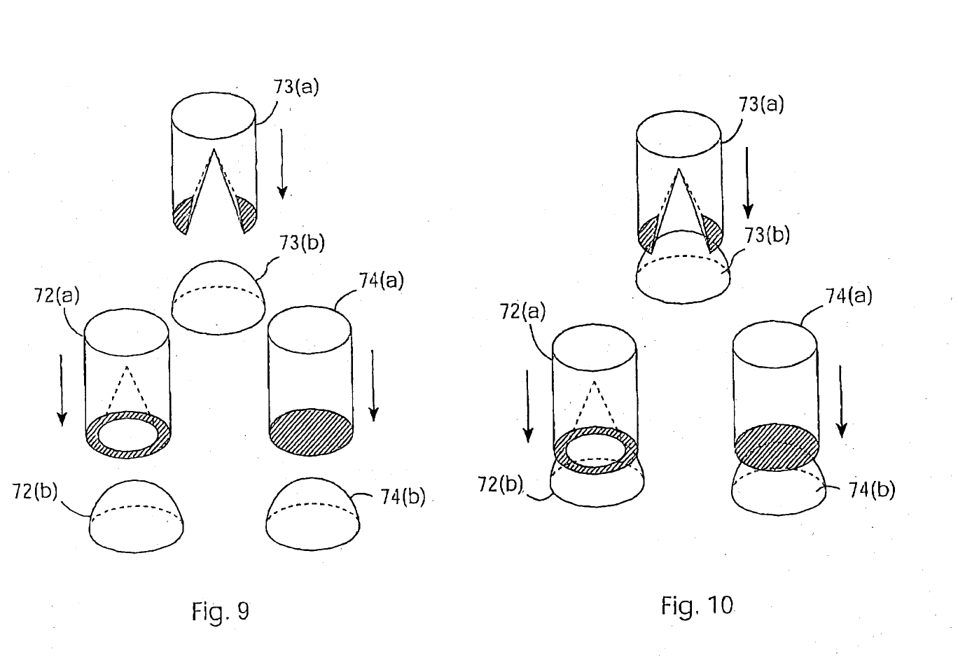

Before describing the recording operations in more detail reference is now made to FIGS. 7 to 10 which illustrate an end effector 70 of the robotic arm 6 placing a disc D on a spindle 41. The arm 9 has a similar end effector.

The end effector 70 comprises a pair of jaws 71 for gripping the substrate disc D. Three pins 72(a), 73(a), and 74(a) are mounted adjacent to the jaws 71. These are for engagement with corresponding hemispheres 72(b), 73(b), and 74(b) respectively on the platter 40. The jaws 71 and the pins 72(a), 73(a), and 74(a) are mounted on a movable support 80 which is connected to an end 81 of the robotic arm by springs 82.

Because the LBR station 3 is mechanically isolated from the stations 2 and 4, its datum frame moves relative to that of the robotic arms 6 and 9. A purpose of the end effector 70 is to accurately place discs D onto the air bearing spindles 41, even with this movement. It does this by complying in a manner such that it settles into a datum frame which is defined by the locator hemispheres which are attached to the granite platter 40, on which the spindle is mounted (i.e. the locator hemispheres are fixed relative to the spindles 41. This is replicated for each spindle.

The table 40 is pre-aligned to a preliminary level with respect to the robotic arms 6 and 9. In operation, the end effector 70 descends from above the spindle 41 with a disc D. The end effector 70 travels until the directional pins 72(a), 73(a), and 74(a) make contact with the locator hemispheres. At the point contact is made between the directional pins and the locator hemispheres, the robotic arm continues to move down, with the end 81 overtravelling relative to the movable support 80. This allows a compliance (X, Y, Z, T) effect to take place. The pin 72(a) has an internal conical surface, the pin 73(a) has an internal V-shape, and the pin 74(a) has a flat base surface. At some point, the extent of the overtravel triggers a sensor, which stops the downward movement. At that time, the pins and associated hemispheres will have constrained the end effector 80. The manner in which this occurs is such as to limit all six degrees of freedom. Any further limitation results in over-constraining which would produce un-repeatable results. The pin 72(a) and the hemisphere 72(b) define X, Y/0, 0 point. The pin 73(a) and the hemisphere 73(b) define Theta of the datum. The combination of all pins and all hemispheres defines the plane.

An alternative approach to the problem of the LBR station 3 moving relative to the remainder of the system is to use machine vision. A target may be attached to the robot end effector 70 and a camera would be mounted directly to on the granite platter 40. Prior to placement, the robotic arm 6 would move to a point over the camera. The camera would then focus on the target and align (via mathematical offsets) the datum frame of the robot and the datum frame of the LBR station. In doing this, the point datum (points where the robot places, picks, etc) would effectively include a realtime offset.

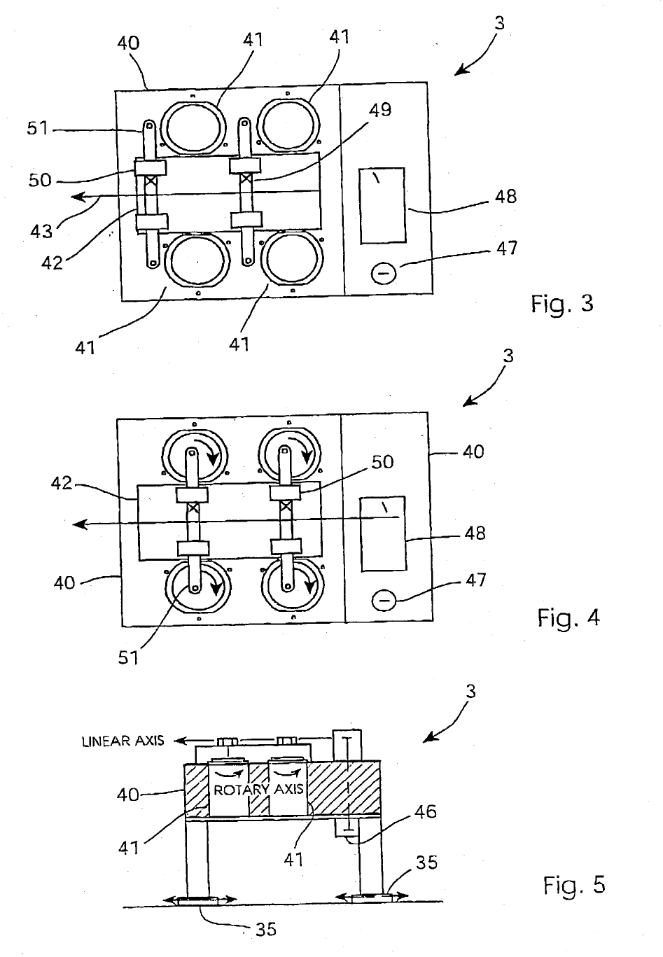

Referring again to FIGS. 3 to 6, the recording heads 51 are moved with very little travel between positions for disc load/unload (FIG. 3) and operative positions (FIG. 4). This minimises inaccuracies introduced by the linear motor 42.

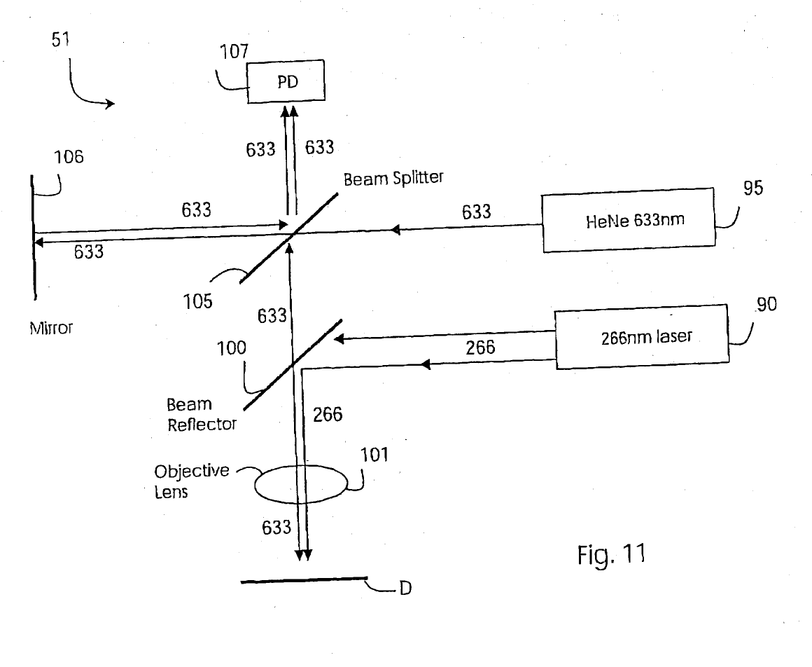

Referring to FIG. 11 a recording laser source (266 nm wavelength) 90 and a control laser source (633 nm wavelength) 95 are illustrated. Both are mounted in the housing 46. Each head 51 operates with two laser beams, namely the 633 nm control beam (common to all spindles) and one of four 266 nm recording laser beams modulated at source for the required recording. Within the head 51 there is a beam reflector 100 for reflecting the recording 266 nm beam onto the disc D via an objective lens 101. A beam splitter 105 acts as an interferometer, receiving the 633 nm control beam outputting two 633 nm beamlets as follows:

A reference beam which is reflected by a mirror 106 and by the beam splitter 105 to a photodiode 107, and

A sensing beam which is transmitted through the beam reflector 100 and onto the disc D, reflected by the disc D back through the beam reflector 100 and the beam splitter 105 to the photodiode 107.

Thus, two 633 nm beams are detected at the photodiode 107, namely a reference beam from the mirror 106 and a sensing beam reflected by the disc D.

Using the principles of constructive and destructive interference, when the two signals (633 nm) are in phase, the signal will be at its highest intensity, and when they go out of phase destructive interference will lower the signal intensity. The output of the phase detector 107 is fed to the controller 62, which in turn controls the transducer 60. This raises and lowers the head 51 to ensure real time correct focusing for consistent laser spot size and shape. Thus it is possible to keep very tight control on the 266 nm recording beam focus condition. The result of this modulation is that if the height of the disc D drifts by 150 nm the photodector output changes from a maximum to a minimum. This provides an accuracy of 10's of nm's and the response time is of the order of kilo Hertz. In more detail, the following are the steps for operation of the LBR station 3.

Step 1—Place glass substrate disc D on the spindle 41 and set in rotation according to the CD, DVD or other density required.

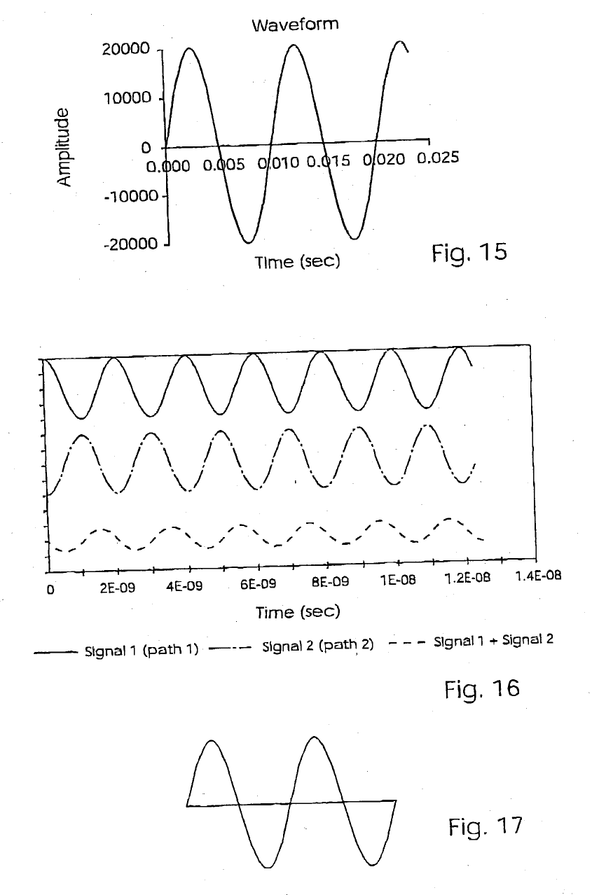

Step 2—Turn on the control beam (633 nm) and allow it to stabilise. A sensing beam divided from the control beam reflects off the beam splitter 105 through the beam reflector 100 through the objective lens 101 onto the glass, reflects back off the glass through the objective lens 101, through beam splitter 105 onto the photodiode 107. The signal received at the photodiode 107 from this beam path (path 1) is represented in FIG. 14. Part of the control beam (the reference beam) makes a path going straight through the beam splitter 105 onto the mirror 106, reflects back from the mirror 106, onto the beam splitter 105, which reflects the beam onto the photodiode 107. The signal received at the photodiode 107 on this path is represented in FIG. 15.

Both the reference and the sensing beams are now entering the photodiode 107. The phase shift of both of the beams entering the photodiode 107 is monitored. If it is assumed that at this point in setup, both beams are out of phase as shown in FIG. 16, the result (lowest plot) will be the output of the photodiode 107. This condition is called destructive interference. For optimum control of the system the beams are calibrated into a condition of constructive interference. To do this one adjusts the distance between the mirror 106 and the beam splitter 105 in either direction to have the effect of moving the phase of the sensing beam path. When the output signal reaches maximum voltage (constructive interference), calibration is complete. At this point the position of mirror 106 is fixed. The sine wave profile output of the photodiode 107 will now be as shown in FIG. 17.

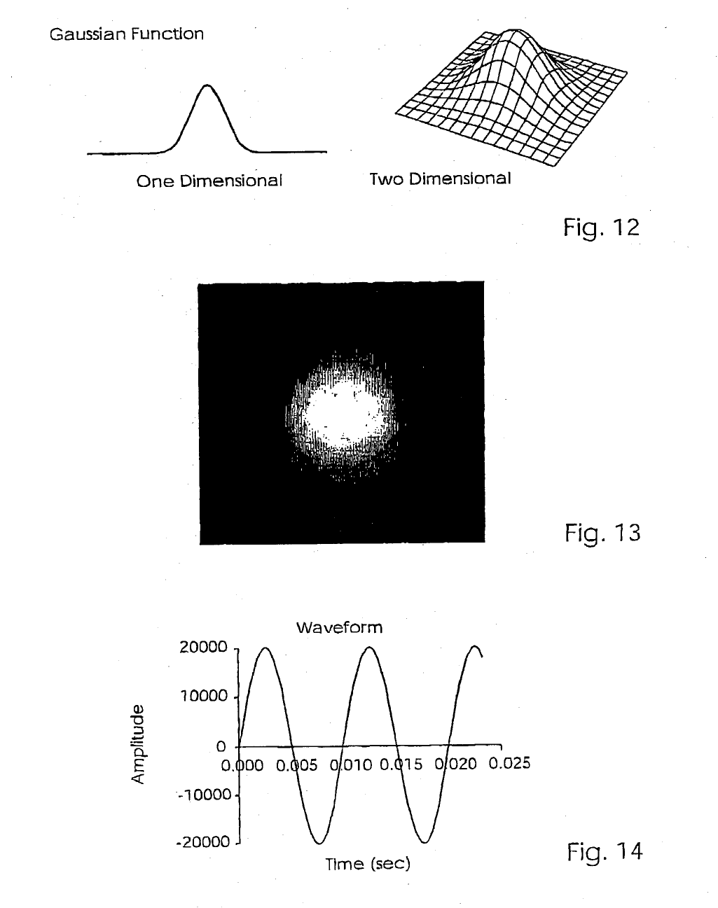

Step 3—Open the shutter 50 for the 266 nm laser source 90 and allow it to stabilise. This deflects off the reflector 100 through the objective lens 101 and onto the glass disc D. This focus spot is Gausian (FIG. 12) and is observed in a CCD camera as illustrated in FIG. 13.

The CCD camera monitoring is used primarily as a setup aid. It consists of a prism placed between the beam reflector 100 and the objective lens 101. This allows the 266 nm recording beam to pass through the prism without change but deflects the reflected recording beam at 45 degrees into a CCD camera to assist with setup.

Step 4—In order to ensure the 633 nm sensing beam is kept in focus, it's phase is compared against its own reference beam by the phase detector 107. If maximum constructive interference is not observed then the distance between the objective lens 101 and the substrate surface D is adjusted. This is done by the transducer 60 moving the recording head 51 until maximum constructive interference is again observed. This is a continuous measurement mechanism.

The controller 62 comprises a PID (proportional integral derivative) circuit to integrate photodetector 107 output so that noise is effectively filtered out. The transducer 60 is a 10 kHz resonant frequency piezo transducer (“PZT”), providing a response time of typically 30 microseconds. This response allows real time movement of the head 51 to track changes in surface level of the glass substrate disc D. It has been found that a transducer of the type having ferroelectric crystals which expand and contract in proportion to applied voltage is particularly suited to this application. An alternative transducer of this type is an electrostrictive actuator having a lead-magnesium-niobate (PHN) crystal. The crystals of the transducer 60, on the other hand are of lead-zirconate-titanate (PZT) ceramic material.

An advantage of using a control beam and monitoring phase difference of sensing and reference beamlets derived from it is that differences in distance between the disc D and the head 51 as small as tens of nm are immediately detected. Furthermore, variations in the paths of the sensing and reference beamlets do not affect the monitoring. A still further advantage is the very fast response time, as outlined above.

An alternative approach is to direct all of the control beam onto the glass substrate disc D and mount a quadrant photodetector centrally in the path of the reflected control beam. For correct focus, each quadrant should detect equal intensity within a given tolerance. However, if the head goes out of focus, the size and shape of the spot on the quadrant photodetector is unevenly distributed around the four quadrants. This approach is satisfactory for selectively large control beam spot sizes, but accuracy suffers for small spot sizes (high density control beam).

Where phase difference between sensing and reference beams is used, the sensing beam may be derived from the recording beam.

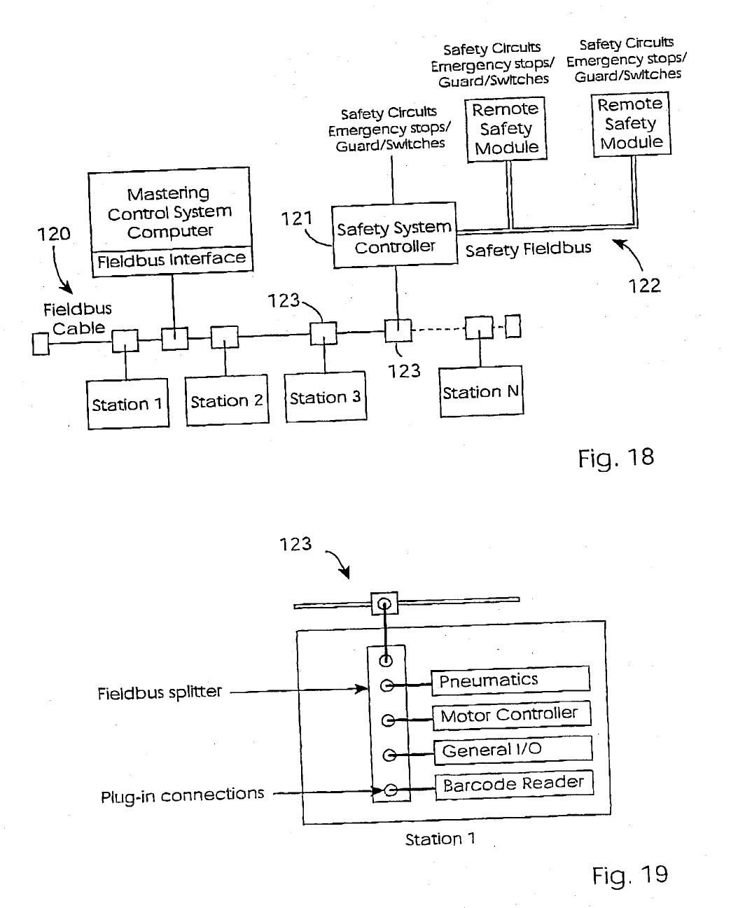

Regarding control of the various processing devices, of the robotic arms 6 and 9, of the spindles 41, and of the laser heads 51 a fieldbus control architecture is used. This achieves real time monitoring of each item by monitoring all electrical parameters. Each device is connected to a fieldbus 120 via the main network cable, as shown in FIG. 18. A safety system controller 121 has a connection to the fieldbus 120. It also has a dedicated safety bus system 122 for connections to safety devices, including emergency stop buttons, light curtains, and door safety switches. Using this system a number of safety zones are set up.

The safety controller 121 is programmable to allow maintenance personnel to shut down certain zones to repair faults while the rest of the machine can remain operational. The safety controller 121 divides diagnostic information back to a main control system via the fieldbus interface. At each device level the wiring is distributed further using the fieldbus. Pneumatic actuators are connected via fieldbus modules, which removes the need for wiring individual solenoids. Motor controllers have adjustable parameter settings via the fieldbus 120 and provide real-time feedback via the fieldbus network. Faulty motor controllers can be replaced without any set-up required by maintenance personnel.

The current consumed by each motor is monitored and logged so that any increases are alarmed. These alarms indicate impending motor or bearing failure, providing the opportunity to change components at a scheduled preventative maintenance time, reducing unplanned downtime. General system inputs and outputs are connected into fieldbus modules 123 which provide rapid connection sockets and reduced wiring lengths. This is illustrated in FIG. 19.

Another aspect of the system controller is that it uses a Web server to allow users on an intranet/internet connection and the appropriate permissions to interact with it. Each user is able to use a standard Web browser to connect to the system 1. This approach makes the connection geographically independent.

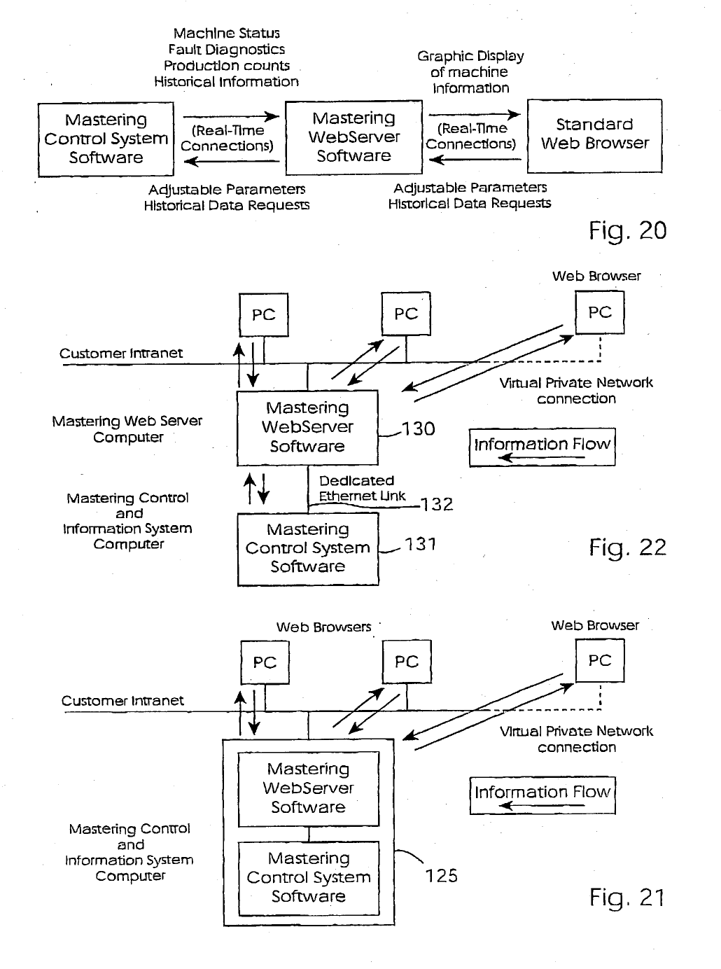

Support engineers are able to connect to the control system via the Web server and provide remote troubleshooting, eliminating the need for costly site visits. The user can view machine status, real-time and historical trend charts, alarm and fault information and adjust pre-defined machine parameters. The Web Server software has a high speed connection to the controller via which it send/receives process and production information. Typical information that is exchanged is demonstrated in FIG. 20. This information is converted into a graphical format that can be viewed by a standard Web browser providing the user has appropriate permissions. Depending on the user's access permissions they may have the ability to make changes to selected machine parameters and also to request historical process and production data from the system 1.

The Web Server software is flexible in that it may reside on the same computer system as the mastering control system or it may reside on it's own server. It also has the capability to connect to multiple mastering systems.

With either option the Web server is connected to the customer factory Intranet via a standard high-speed Ethernet connection.

The Web browsers that have access to the system will reside on the customer intranet.

An option is shown in FIG. 21, in which the Web server software and the mastering control system software reside on the same computer 125. This computer is connected to the factory intranet and all communication to the Web browsers are channeled through this interface. Another option is shown in FIG. 22, in which a Web server 130 resides on a separate computer system 131 to the controller. There is a dedicated high speed ethernet link 132 between the two systems. The Web server is then connected to the customer Intranet.

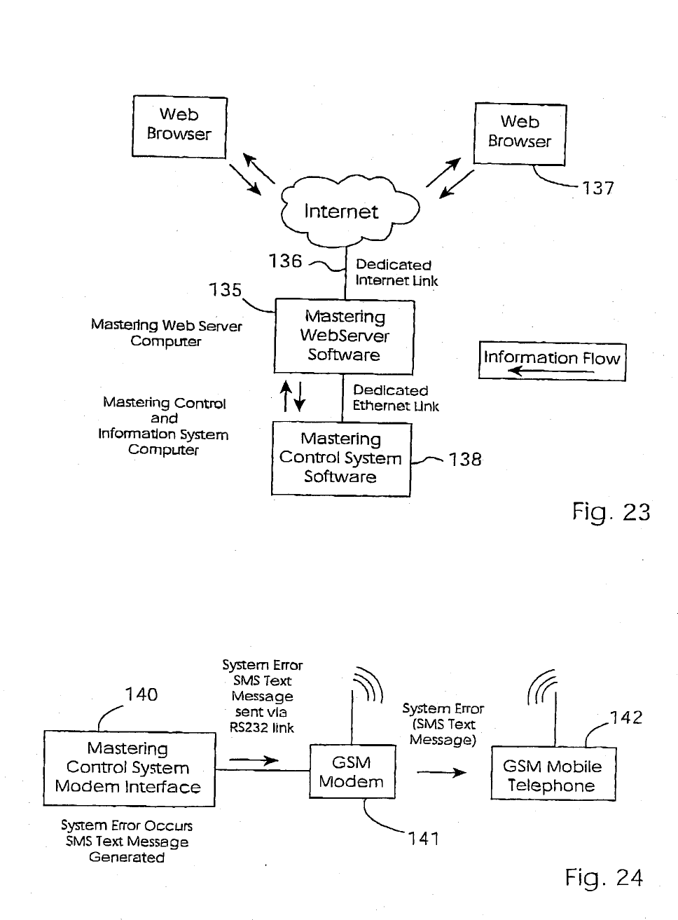

A further option is illustrated in FIG. 23, in which Web server software 135 resides on it's own computer which is connected to multiple systems via a dedicated ethernet LAN 136. The Web Server is connected to a factory Intranet. The Web server handles all communication between Web browsers 137 and the system controller 138.

For all options the connection to the Intranet may be a dedicated connection.

Speed of operation of the system 1 requires that process problems or machine errors are reported immediately to prevent yield problems and to minimise downtime. Visual and audible fault indicators on the machine may not be sufficient to notify users of process variations or system errors. As shown in FIG. 24 the system 1 overcomes the problem by using SMS text messaging for machine diagnostic information. A software interface 140 is linked between the system controller and a GSM modem 141. The interface communicates with the modem via an RS232 link and has the ability to send and receive SMS text messages to a GSM devices 142. The interface 140 may be used to notify mastering equipment operators of machine failures. This removes the need for interfacing to plant pager systems and it provides rapid response times. If a serious system error occurs, the mastering control system generates a fault code. The interface 140 receives this fault code and generates an SMS text message. The SMS text message is sent to the GSM modem 141 via the RS232 link. The GSM modem then sends the SMS text message to the appropriate personnel devices 142.

The interface may also be used to send scheduled status reports from the system controller to selected personnel. Thus, when a scheduled report is due, the mastering control system generates the status information necessary (production counts/yield/downtime). The interface 140 receives this status information and generates an SMS text message. The SMS text message is sent to the GSM modem 141 via an RS232 link, and the GSM modem 141 sends the SMS text message to the appropriate personnel devices 142.

The interface 140 may also be used to allow selected personnel to request and receive status information by SMS text messaging. A person requesting information sends an SMS text message to the GSM modem 141. The GSM modem 141 sends a notification to the interface 140 that a next message has arrived. The interface 140 processes the text message and generates a reply message. The reply SMS text message is sent to the GSM modem 141, and the SMS text messages is sent to the information requester device 142.

The above services can also be delivered by the Global Packet Radio Service (GPRS) or more commonly know as the 2.5 G mobile technology. It can also be delivered by the Universal Mobile Telecommunications System (UMTS) or more commonly know as third generation (3G) mobile system. This technology will be made available on any compliant hand help device such as a personal digital assistant.

It will be appreciated that the invention provides for comprehensive and automated D master recording media production. There is excellent accuracy due to the automatic focusing operations and isolation of robotic equipment from the LBR station. Thus, variations in medium surface level are accomaded, however small they may be. The arrangement of three stations allows highly efficient production, without adversely affecting quality.

The invention is not limited to the embodiments described but may be varied in construction and detail.

1. A master recording medium production system comprising a controller, a table supporting a spindle for supporting a recording medium substrate, a recording head for delivering a recording laser beam onto the substrate, a drive means for moving the recording head, and focusing means for focusing the recording laser beam, characterised in that, the focusing means comprises means for dynamically compensating for variations in level of the substrate during recording.

2. A system as claimed in claim 1, wherein the focusing means comprises a transducer (60) mounted to dynamically vary position of the recording head (51).

3. A system as claimed in claim 2, wherein the transducer (60) is of the type in which crystals expand and contract in response to a sensing signal.

4. A system as claimed in claim 3, wherein the transducer is a piezoelectric transducer.

5. A system as claimed in claim 1, wherein the focusing means comprises means (95, 105, 100) for directing a sensing laser beam at the substrate and means for monitoring reflection of the sensing beam.

6. A system as claimed in claim 5, wherein the focusing means comprises means for monitoring phase difference between the reflected sensing beam and a reference beam.

7. A system as claimed in claim 6, wherein the focusing means comprises means (105, 106) for extracting the sensing and the reference beams from a single beam.

8. A system as claimed in claim 5, wherein the focusing means comprises means for monitoring intensity of the reflected sensing beam.

9. A system as claimed in claim 5, wherein the sensing beam has a wavelength in the range of 200 nm to 700 nm.

10. A system as claimed in claim 1, wherein the spindle (41) and the recording head (51) are mounted on a table (40) and the system further comprises a pre-recording station (2) for performing pre-recording operations and a post-recording station (4) for performing post-recording operations.

11. A system as claimed in claim 10, wherein the table (40) is mounted on a damping mechanism (35) independently of the pre-recording station and the post-recording station, for mechanical isolation.

12. A system as claimed in claim 1, wherein the pre-recording station (2) and the post-recording station (4) each comprise a plurality of processing devices (5, 8) mounted in a generally circular arc, and a robotic arm (6, 9) comprising means for picking and placing a substrate at each processing device.

13. A system as claimed in claim 12, wherein each robotic arm (6, 9) is centrally mounted and comprises means for accessing processing devices by rotation about a vertical axis.

14. A system as claimed in claim 12, wherein each robotic arm (6, 9) has a span encompassing the spindle (41) and comprises locators (72(a), 73(a), 74(a)) for engagement with corresponding locators (72(b), 73(b), 74(b)) on the table (40).

15. A system as claimed in claim 14, wherein the table locators (72(b), 73(b), 74(b)) comprise means for presenting a spherical surface to the robotic arm locators, and the robotic arm locators comprise a pin (72(a)) having a circular rim for engagement with a table locator, a pin (73(a)) having a V-shaped grove for engagement with a table locator, and a pin (74(b)) having a flat surface for engagement with a table locator.

16. A system as claimed in claim 1, wherein the system further comprises a laser source (90) mounted on the underside of the table (40), and the table (40) has an aperture (47) for passage of a laser beam from the source to the recording head (51).

17. A system as claimed in claim 1, wherein the recording head (51) is mounted on a carriage driven by a linear motor having an air bearing, said linear motor also supporting an optical system (49) and a shutter (50) for delivering a beam to the recording head (51).

18. A system as claimed in claim 1, wherein the system comprises a plurality of spindles, and a recording head (51) associated with each spindle.

19. A system as claimed in claim 18, wherein the recording heads (51) are mounted on a linear motor (42) having an air bearing.

20. A system as claimed in claim 1, wherein each spindle (41) is mounted within a cavity in the table (40).

21. A system as claimed in claim 12, wherein the controller comprises a fieldbus system (120) having a node associated with each processing device, with each spindle (41), and with each recording head (51).

22. A system as claimed in claim 21, wherein the fieldbus system (120) comprises a safety system controller (121) connected to remote safety modules.

23. A system as claimed in claim 1, wherein the controller comprises a Web interface (125) for remote control using a browser.

24. A system as claimed in claim 1, wherein the controller comprises means (140) for transmitting wireless notification signals to a mobile device (142) in a mobile network.
